(19) United States
(12) Patent Application Publication
(10) Pub. No.: US 2005/0183052 A1
(43) Pub. Date: Aug. 18, 2005

(54) Computer-implemented design tool for synchronizing mechanical and electrical wire harness designs

(76) Inventor: Armand R. Ash-Rafzadeh, Northville, MI (US)

Correspondence Address: HARNESS, DICKEY & PIERCE, P.L.C., P.O. BOX 828, BLOOMFIELD HILLS, MI, 48303, US

(21) Appl. No.: 10/779,565

(22) Filed: Feb. 16, 2004

(51) Int. Cl. G06F 9/45

(52) U.S. Cl. 716/8

(57) ABSTRACT

A computer-implemented design tool is provided for analyzing a wire harness design for an electrical systems. The design tool includes: a synchronizing rule set residing in a data store; and a synchronizer adapted to receive topographical data for at least one wire harness in the electrical system and wire layout data for at least one wire routed in the wire harness and operable to merge the wire data with the topographical data to form a comprehensive wire harness data file in accordance with the synchronizing rule set; and a user interface for manipulating data in the wire harness data file.

### FIELD OF THE INVENTION

The present invention relates generally to a computer-implemented design tool for analyzing wire harness designs for electrical systems.

### BACKGROUND OF THE INVENTION

A wire harness design for an electrical system includes two primary components: a mechanical design of the wire harnesses used to route connections between electrical components in an electrical system; and an electrical design of the electrical system, including wire layouts. Traditionally, each of these designs are completed by different parties utilizing different design tools. For instance, the mechanical design is typically done by a mechanical engineer using one of many well known computer-aided design (CAD) tools. On the other hand, the electrical design is typically done by an electrical engineer manually or, alternatively, using a different design tool, such as the TransCable design tool commercially available from Mentor Graphics Corporation. Synchronizing the two designs can be a very lengthy and tedious process.

Thus, there is a need to for a design tool which automatically synchronizes the mechanical and electrical design data into a unifying data format which facilitates further modifications to and assessment of the overall wire harness design.

### SUMMARY OF THE INVENTION

In accordance with the present invention, a computer-implemented design tool is provided for analyzing a wire harness design for an electrical systems. The design tool includes: a synchronizing rule set residing in a data store; and a synchronizer adapted to receive topographical data for at least one wire harness in the electrical system and wire layout data for at least one wire routed in the wire harness and operable to merge the wire data with the topographical data to form a comprehensive wire harness data file in accordance with the synchronizing rule set; and a user interface for manipulating data in the wire harness data file.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

FIG. 1 is a block diagram of a computer-implemented design tool for analyzing wire harness designs in accordance with the present invention;

FIG. 2 a program flow diagram for an exemplary embodiment of the synchronizing component of the design tool according to the present invention;

FIG. 3 is a class diagram for the object oriented architecture employed in the exemplary embodiment of the present invention; and

FIG. 4A and 4B illustrate exemplary graphical user interfaces which may be employed by the design tool of the present invention.

### DETAILED DESCRIPTION OF THE PREFERRED EMBODIMENTS

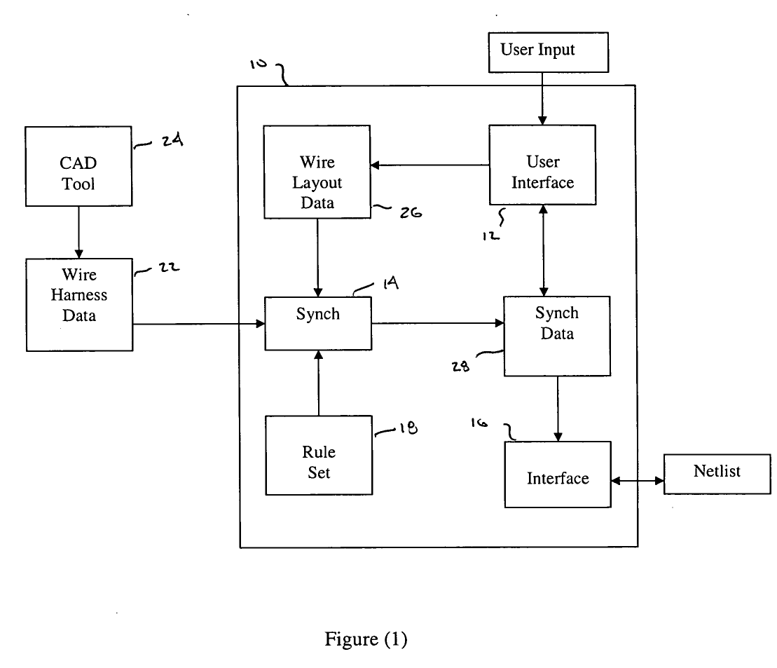

FIG. 1 depicts a computer-implemented design tool 10 for analyzing wire harness designs in accordance with the present invention. The design tool 10 is generally comprised of a graphical user interface 12, a synchronizer 14 and an export interface 16. The design tool 10 also includes a knowledge-based rule set 18 residing in a data store.

In one aspect of the present invention, the design tool 10 is configured to synchronize the mechanical design data for a wire harness with the electrical design data for a wire harness into a comprehensive data format which in turn may be more easily manipulated by a design engineer. To do so, the synchronizer 14 is adapted to receive mechanical design data 22 from a CAD tool 24. The mechanical design data 22 is generally indicative of the physical attributes of an electrical system. In an exemplary embodiment, the mechanical design data 22 is three-dimensional topographical data for at least one wire harness in the electrical system, where the wire harness design includes connectors, bundles, takeouts, splices, dressings, retainers, brackets, etc. as is well known in the art. The mechanical design data is extracted from the CAD tool by the synchronizer 14 as further described below.

Likewise, the synchronizer 14 is adapted to receive electrical design data 26 for the electrical system. The electrical design data 26 is generally indicative of the electrical attributes of the electrical system. For instance, the electrical design data may be wire layouts contained within the wire harness, including splices, connectors and other wire-related data. In this case, the electrical design data 26 is input via the user interface 12 into the tool.

The synchronizer 14 is further operable to automatically merge (or “synchronize”) the mechanical design data 22 with the electrical design data 26 into a comprehensive data file 28. The merge operation is performed in accordance with a knowledge based rule set 18 accessible to the synchronizer 14. The comprehensive data file 28 provides a unifying format which facilitates further assessment of the wire harness design.

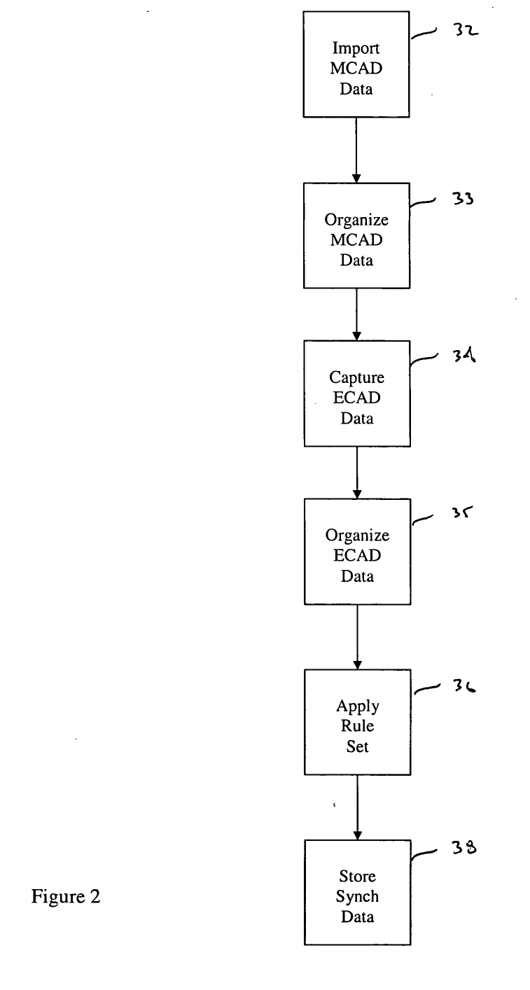

A more detailed program flow diagram for the synchronizer 14 is set forth in FIG. 2. First, the mechanical design data for a given wire harness is imported at 32 from an applicable CAD tool. In an exemplary embodiment, the design tool 10 interfaces with the I-DEAS CAD tool which is commercially available from EDS. In particular, the mechanical design data is extracted using an application programming interface provided by the I-DEAS CAD tool. It is readily understood that the design tool 10 may also be configured to interface with other known CAD tools.

Extracted mechanical design data is then organized at step 33 by the synchronizer 14 in an object oriented form. An exemplary embodiment of the object oriented architecture is set forth below. The top level class of the object oriented hierarchy is defined as a harness class. The harness class in turn includes the following subclasses: bundle, connector, splice, takeout and other parts in the assembly (PIA). It is readily understood that other architectural arrangements are also within the scope of the present invention.

Each of these subclasses are also defined. A bundle is a group of wires which may be in the form of a tube, a wrapping or shielded metal. The bundle class includes bundle identifier, bundle length, and two bundle end points. A connector connects a harness to a module or another harness. The connector class includes a connector identifier, a number of cavities (i.e., the number of terminals inside a connector) and a netlist program template. A splice is a connection point between several wires. The splice class includes a splice identifier, a bundle segment in which its contained, a reference point and its distance, a splice type and a netlist program template. A take out is a mechanical extension from a bundle. The take out class includes a take out identifier, a bundle segment where it occurs, a reference point and its distance. A PIA may be in the form of a bracket, a retainer, tape or other non-electrical components associated with the harness design. The PIA class includes an identifier, a type, a reference point and its length.

Next, the synchronizer 14 receives electrical design data for the harness design as shown at step 34. In an exemplary embodiment, the user interface 12 cooperably operates with the synchronizer 14 to prompt the design engineer for applicable design data. For each electrical component (as ascertained from the mechanical design data), the user is prompted to input electrical design data for the identified component. In this way, the electrical design data is input by a design engineer via the user interface 12 into the design tool. However, it is also envisioned that the synchronizer 14 may be configured to extract the electrical design data from an applicable design tool or to otherwise import the design data into the tool.

To ensure data integrity, a set of knowledge-based input rules may be applied by the synchronizer 14 to the electrical design data. For instance, wire sizes and wire specs can only be selected from a list of predefined values. In another instance, a wire can only be assigned to available bundles as defined by the mechanical design data. To the extent that a wire is assigned to more than one bundle, the bundles must be interconnected bundles. Similarly, the synchronizer verifies that wire end points correlate to the end points of the assigned bundle. These above input rules are merely illustrative. It is readily understood that other types of input rules may be defined and applied to the electrical design data.

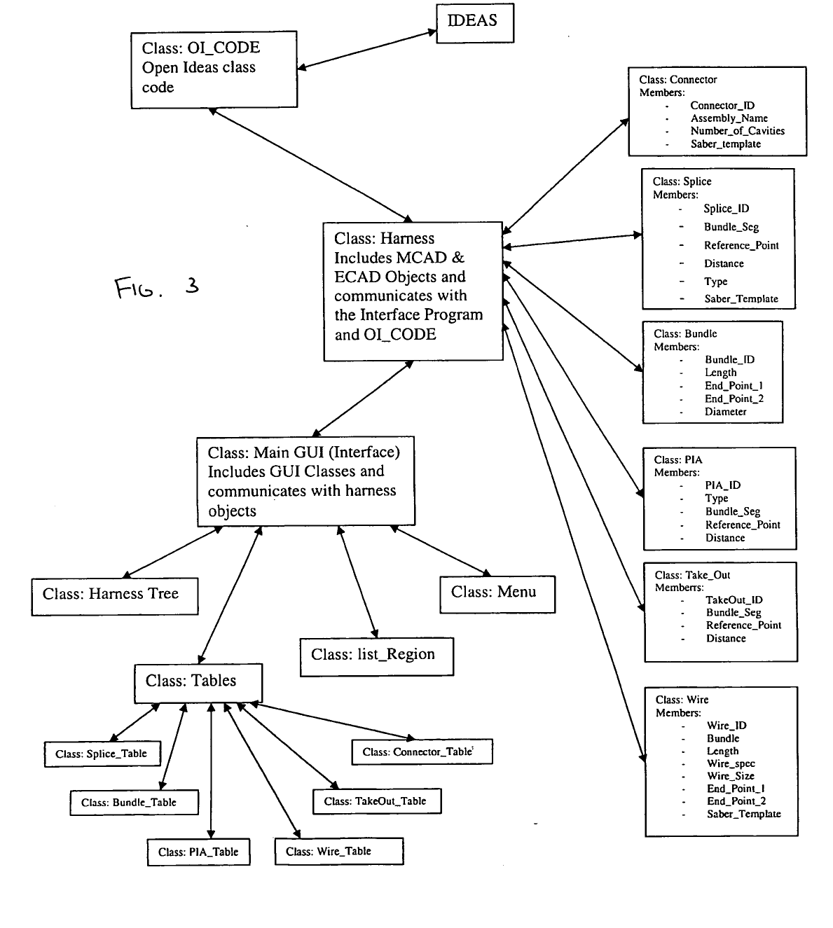

Electrical design data is also organized at step 35 by the synchronizer 14 in an object oriented form. In the exemplary embodiment, electrical design data is organized within the above noted harness class. In particular, the harness class further includes a wire subclass having members such as a wire identifier, a bundle segment in which its contained, wire length, wire size, wire specification, two wire endpoints and a netlist program template. A class diagram for an exemplary embodiment of the above-described object oriented architecture is provided in FIG. 3. Again, it is readily understood that other architectural arrangements are also within the scope of the present invention.

The synchronizer 14 then proceeds at step 36 to synchronize the mechanical design data with the electrical design data in accordance with the remainder of the knowledge-based rule set 18. First, the synchronizer 14 enforces a series of nomenclature-based rules in relation to the harness design data. Variable names defined within the system employ the following naming convention: W=signifies applicant's design tool; I=identifier; C=connector; T=take out; L=splice; and P=other parts in the assembly. For instance, a variable indicative of a connector is a named WCI_n, where n is a sequentially increased integer. To provide consistency, variables are defined in this way whether they are user defined variables or system defined variables.

Second, the synchronizer 14 applies additional data integrity rules to the harness design data. For example, the length of a wire is automatically correlated to the length of its assigned bundles. In another example, the distance a splice is defined from its reference point must be smaller or equal to the length of the bundle in which the slice is contained in. Similarly, the distance of any PIA from its reference must be smaller or equal to the length of the bundle in which it is located. Although these three rules represent an exemplary rule set, it is readily understood that other types of data integrity rules fall within the scope of the present invention.

Lastly, the synchronized harness design data is stored at step 38 in a comprehensive wire harness data file by the synchronizer 14. The format of the data file is as follows:

| Record Name | Field Name |
|---|---|
| Bundle_ID | Bundle_Length |
| | Bundle_End_Point_1 |
| | Bundle_End_Point_2 |
| Connector_ID | Connector_Assembly_Name |
| | Connector_Number_of_Cavities |
| | Connector_Saber_Template |
| Splice_ID | Splice_Bundle_Seg_Array |
| | Splice_Reference_Point |
| | Splice_Distance |
| | Splice_Type |
| | Splice_Saber_Template |
| TakeOut_ID | TakeOut_Bundle_Seg_Array |
| | TakeOut_Reference_Point |
| | TakeOut_Distance |
| PIA_ID | PIA_Type |
| | PIA_Bundle |
| | PIA_Reference_point |
| | PIA_Distance |
| Wire_ID | Wire_Bundle_Array |
| | Wire_Length |
| | Wire_Spec |
| | Wire_Size |
| | Wire_End_Point_1 |
| | Wire_End_Point_2 |
| | Wire_Saber_Template |

Each of these fields are of a text type having a variable field size. It is noteworthy that the format of the data file varies from the data format, if any, in which the mechanical or electrical design data was received by the design tool. Thus, the mechanical and electrical design data has been merged into a single data file easily accessible to the design tool.

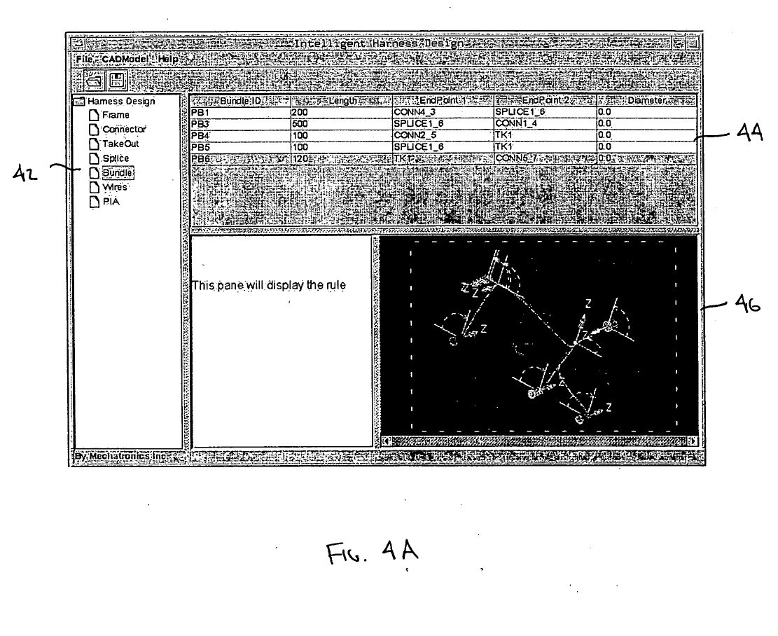

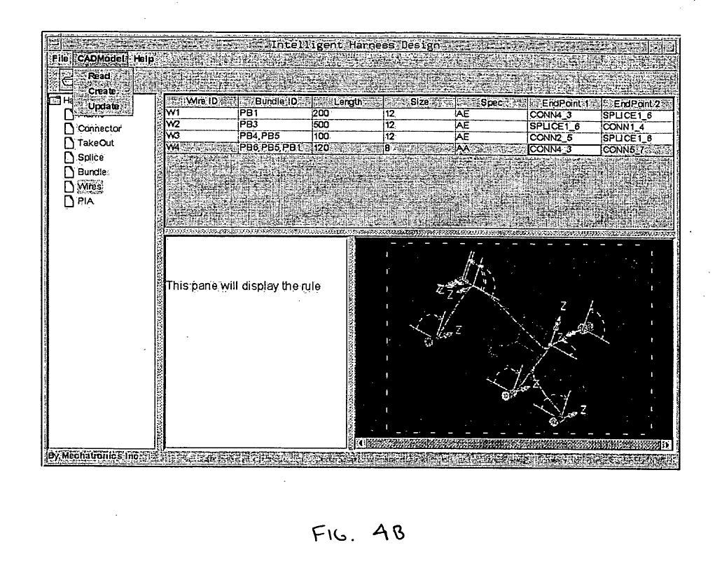

The graphical user interface 12 is designed to view and manipulate the underlying design data for the wire harness by using the comprehensive data file 28. An exemplary graphical user interface 12 is illustrated in FIGS. 3A and 3B. In this exemplary embodiment, the primary components of a harness design are displayed at 42 in a window tree form. When a component type is selected, each instance of that component and corresponding attribute data for that component type are displayed in table form at 44 in an adjacent window. For instance, bundle data, such as bundle identifier, bundle length, and two bundle end points, may be displayed as shown in FIG. 4A. In another instance, wire data, such as wire identifier, bundle identifier, wire length, wire size and other associated wire data, may be displayed as shown in FIG. 4B. Thus, mechanical design data and electrical design data for the wire harness design are easily accessible through a single user interface. In addition, a three-dimensional graphical rendering of the wire harness design may be displayed at 46. Although reference is provided to a particular graphical user interface layout, it is readily understood that other types of interfaces are within the scope of the present invention.

In operation, a design engineer may elect to modify one or more design values using the user interface. Modified values are passed from the user interface 12 to the synchronizer 14. Thus, the modified values are directly updated in comprehensive data file 28 in accordance with the knowledge based rule set. For example, if a given wire is assigned to an additional bundle, then the length of that wire may be automatically updated in the data file to correspond to the total length of its assigned bundles. In this way, mechanical and electrical design data for a harness design may be concurrently view and modified using a single design tool.

Referring to FIG. 1, the design tool 10 further includes an export interface 16 which may be used to interface with an electrical simulation tool, such as the Saber simulation tool, the PSpice simulation tool, or other known computer-aided engineering tools. As noted above, each electrical component of the harness design includes a netlist program template. At the request of the design engineer, the export interface 16 is operable to access the netlist program templates contained in the comprehensive data file 28 and compile an output file formatted for input into an applicable electrical simulation tool. In an exemplary embodiment, Saber compatible templates are stored for each electrical component and the export interface generates a netlist suitable for use by the Saber simulation tool as is well known in the art.

In this way, an electrical simulation and/or analysis of the electrical system may be performed by an design engineer using the simulation tool. If simulation results are not satisfactory, changes can be made to the design values of the harness design using the user interface of the design tool in the manner described above. A netlist for the modified harness design can then be generated by the design tool, such that simulation and analysis of the design may be performed iteratively until a satisfactory design is achieved.

The description of the invention is merely exemplary in nature and, thus, variations that do not depart from the gist of the invention are intended to be within the scope of the invention. Such variations are not to be regarded as a departure from the spirit and scope of the invention.

1. A computer-implemented design tool for analyzing a wire harness design for an electrical system, comprising:
a data store containing a synchronizing rule set;
a synchronizer adapted to receive physical data indicative of physical attributes of an electrical system and electrical data indicative of electrical attributes of the electrical system, the synchronizer connected to the data store and operable to merge the physical data with the electrical data to form a synchronized data file in accordance with the synchronizing rule set; and
a user interface operable to manipulate data in the synchronized data file.

2. The computer-implemented design tool of claim 1 wherein physical data is further defined as topographical data for at least one wire harness in the electrical system.

3. The computer-implemented design tool of claim 2 wherein the topographical data is selected from the group consisting of bundle data, connector data, splice data, take out data and non-electrical component data.

4. The computer-implemented design tool of claim 1 wherein the synchronizer is connected to a computer-aided design (CAD) tool and operable to extract the physical data for the electrical system from the CAD tool.

5. The computer-implemented design tool of claim 1 wherein electrical data is further defined as wire layout data for at least one wire associated with the electrical system.

6. The computer-implemented design tool of claim 1 wherein the electrical data is input via the user interface.

7. The computer-implemented design tool of claim 1 wherein the synchronized data file having a data format different from a format for the physical data.

8. The computer-implemented design tool of claim 1 further comprises an interface having access to the synchronized data file and operable to generate an output file formatted for input into at least one of an electrical simulation tool and a computer-aided engineering tool.

9. The computer-implemented design tool of claim 1 wherein the user interface is operable to display data from the synchronized data file.

10. The computer-implemented design tool of claim 1 wherein the user interface is adapted to receive changes to data contained in the synchronized data file and to store changes to the data in the synchronized data file.

11. A computer-implemented design tool for analyzing a wire harness design for an electrical systems, comprising:
a data store containing a synchronizing rule set;
a synchronizer adapted to receive topographical data for at least one wire harness in the electrical system and wire layout data for at least one wire routed in said wire harness, the synchronizer connected to the data store and operable to merge the wire data with the topographical data to form a comprehensive wire harness data file in accordance with the synchronizing rule set; and
a user interface operable to manipulate data in the wire harness data file.
